(19) United States
(12) Patent Application Publication
(10) Pub. No.: US 2003/0083872 A1
(43) Pub. Date: May 1, 2003

(54) Method and apparatus for enhancing voice recognition capabilities of voice recognition software and systems

(76) Inventor: Dan Kikinis, Saratoga, CA (US)

Correspondence Address: CENTRAL COAST PATENT AGENCY, PO BOX 187, AROMAS, CA, 95004, US

(21) Appl. No.: 10/273,443

(22) Filed: Oct. 17, 2002

Related U.S. Application Data
(60) Provisional application No. 60/335,056, filed on Oct. 25, 2001.

(51) Int. Cl. G10L 15/06

(52) U.S. Cl. 704/243

(57) ABSTRACT

An enhanced voice recognition system has a central processing unit for processing and storing data input into the system; a microphone configured to the central processing unit for recording sound input; at least one camera configured to the central processing unit for recording image data input; and at least one software module for receiving, analyzing, and processing the input. In a preferred embodiment, the system uses tracked motion values from the image data processed by at least one software module to produce values that are used to enhance the accuracy of voice recognition.

### CROSS-REFERENCE TO RELATED DOCUMENTS

The present application claims priority to U.S. provisional patent application entitled “Enhanced Input Device Providing Visual Cues for Enhanced Voice Recognition Systems”, serial No. 60/335,056 filed on Oct. 25, 2001, disclosure of which is incorporated herein in its entirety by reference.

### FIELD OF THE INVENTION

The present invention is in the field of voice recognition software including input apparatus, and pertains more particularly to methods and apparatus for combining visual and audio to produce enhanced recognition for systems.

### BACKGROUND OF THE INVENTION

Speech recognition systems are a relatively new advance in technology used for communication and in word processing. Speech recognition systems as are known to those skilled in the art are fast becoming popular for a number of communication and word processing applications. Telephony applications use speech recognition as well, as do a variety of computer programs.

A problem with speech recognition as practiced in a computer environment is that recognition of commands and verbal input are not very accurate on most computers. This is due to several factors including lack of adequate voice training, lack of processing power, lack of enough vocabulary input, faulty or low-quality input apparatus and so on. The industry has been recognized in the art as imperfect and technical advances are required before speech recognition becomes a commercial reality.

Another popular application, voice-activated telephone systems are also well-known. These systems work without requiring vocabulary pre-entry or voice training. However, they are very limited in what terms can be recognized and how much interaction can actually occur. For the most part they are unusable for heavy recognition functions and falter, at least in small part due to background noise typical of a normal telephoning environment today, particularly when mobile telephones are used.

Some research is underway at the time of writing of this patent specification that focuses on ways to integrate voice and visual maps in order to improve speech recognition by combining the two. Papers written on the subject are available at

http://www.research.ibm.com/AVSTG/main.html.

Several drawbacks exist in the current research in that extensive bitmap modeling of mean facial features produces only minimal improvement in overall voice recognition.

Therefore, what is clearly needed is method and apparatus for enhancing voice recognition capabilities in terms of actual voice recognition by combining visual aids that can be quantified as delta values for recognition purposes with actual audio recognition possibilities.

### SUMMARY OF THE INVENTION

In a preferred embodiment of the present invention an enhanced voice recognition system is provided, comprising a central processing unit for processing and storing data input into the system, a microphone configured to the central processing unit for receiving audio input, at least one camera configured to the central processing unit for receiving image data input, and at least one software module for receiving, analyzing, and processing inputs. The system is characterized in that the system uses motion values from the image data to enhance the accuracy of voice recognition.

In a preferred embodiment the microphone and at least one camera are provided substantially at the end of a headset boom worn by the user, and in some embodiments the microphone and at least one camera are provided substantially at the end of a pedestal-microphone. There may a boom camera and at least one regular camera.

Also in preferred embodiments the at least one software module includes voice recognition, image correction, motion tracking, motion value calculation, and text rendering based on comparison of motion values to text possibilities. The central processing unit in some cases enables a desktop computer.

In another embodiment of the invention there is a teleconferencing module, a data link to a telecommunications network, and a client application distributed to another central processing unit having access to the telecommunications network. This embodiment is characterized in that the input image data is processed by the at least one software module and delivered as motion values to the teleconference module along with voice input, whereupon the motion values are attached to the voice data, transmitted over the telecommunications network, and processed by the distributed client application to enhance the quality of the transmitted voice data.

In some embodiments the telecommunications network is the Internet network, and in some other embodiments the telecommunications network is a telephone network. In some cases the telecommunications network may be a combination of the Internet network and a telephone network. The microphone and at least one camera may be provided substantially at the end of a headset boom worn by the user, or at the end of a pedestal-microphone. The at least one camera may include a boom camera and at least one regular camera. In some cases the at least one software module includes voice recognition, image correction, motion tracking, combined motion value calculation, and text rendering based on comparison of motion values to text possibilities.

In another aspect of the invention a software application for enhancing a voice recognition system is provided, comprising at least one imaging module associated with at least one camera for receiving image input, at least one motion tracking module for tracking motion associated with facial positions of an image subject, and at least one processing module for processing and comparing processed motion values with voice recognition possibilities. The application is characterized in that the application establishes motion points and tracks the motion thereof during a voice recognition session, and the tracked motion is resolved into motion values that are processed in comparison with voice recognition values to produce enhanced voice recognition results.

In some embodiments of the application a whisper mode is provided wherein motion tracking and resulting values are relied more on than voice processing to produce accurate results. There may also be a teleconferencing module.

In some cases the values resulting from motion tracking may be attached to voice data transmitted in a teleconferencing session through the teleconferencing module. There may also be a client application distributed to the receiving central processing unit of a receiving station of the teleconference call.

In yet another aspect of the invention a method for enhancing voice recognition results in a voice recognition system is provided, comprising (a) providing at least one camera and image software for receiving pictures of facial characteristics of a user during a voice recognition session; (b) establishing motion tracking points at strategic locations on or about the facial features in the image window; (c) recording the delta movements of the tracking points; (d) combining the tracked motion deltas of individual tracking points to produce one or more motion value; (e) comparing the motion values to voice recognition values and refining text choices from a list of possibilities; and (f) displaying the enhanced text commands or renderings.

In some embodiments of the method, in step (a), the at least one camera includes a boom camera and at least one fixed camera, and in some embodiments the at least one camera is a boom camera mounted to a headset boom. Further, the at least one camera may be a fixed camera.

In some embodiments, in step (b), the tracking points are associated with one or more of the upper and lower lips of the user, the eyes and eyebrows of the user, and along the mandible areas of the user. In some embodiments, in step (e), the motion values are relied on more heavily than the voice recognition values.

### BRIEF DESCRIPTION OF THE DRAWING FIGURES

FIG. 1 is an architectural overview of a typical voice recognition environment according to prior-art.

FIG. 2 is a perspective view of an input device and user reference configured according to an embodiment of the invention.

FIG. 3 is a plan view of a distorted camera view of the face and mouth of the user of FIG. 2.

FIG. 4 is a plan view of a corrected camera view of the same image taken in the example of FIG. 4.

FIG. 5 is a block diagram illustrating motion points used for analyzing and processing delta motion by algorithm.

FIG. 6 is an overview of a visually aided voice recognition system according to various embodiments of the present invention.

### DESCRIPTION OF THE PREFERRED EMBODIMENTS

According to a preferred embodiment of the present invention, a combination visual/voice recognition system is provided. The methods and apparatus of the invention are described in enabling detail below.

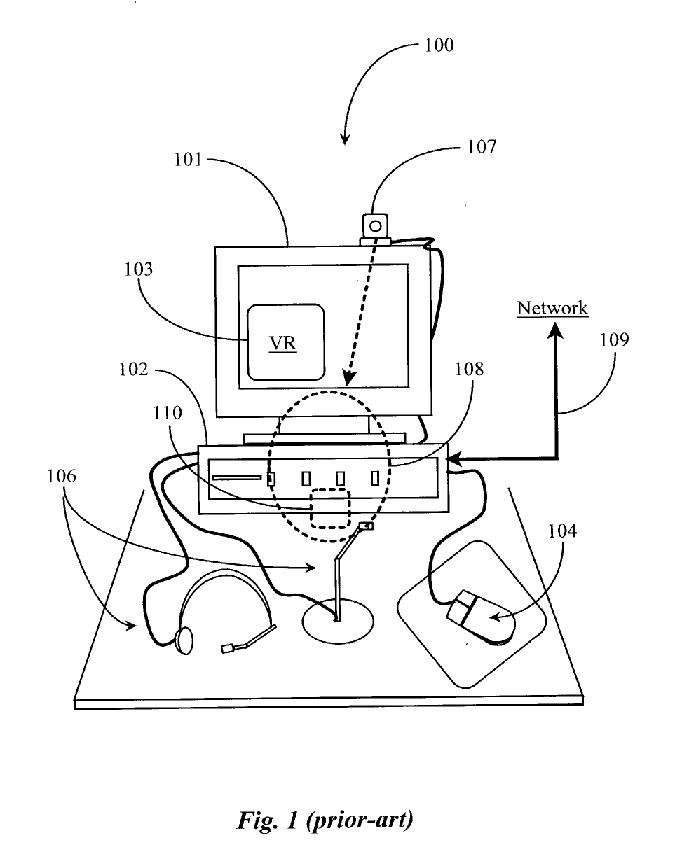

FIG. 1 is an architectural overview of a typical voice recognition environment 100 according to prior-art. System 100 comprises a desktop computer 102 having a central processing unit (CPU) and a graphical user display (GUI) 101 known and typical for desktop computer systems. In a typical prior-art use example, Computer 102 is adapted with sufficient memory and disk space for supporting typical operating software, word processing software, telephony software, and the like.

In this example computer 102 supports a voice recognition software application (VR) 103. VR 103, most typically is a standalone software application that can be integrated with word processing applications, e-mail applications, calendar applications, and so on. VR 103 operates with the use of various input devices 106 capable of receiving a user's voice for input into the software application. For example, a pedestal-style microphone shown as one of input devices 106 is sometimes used in conjunction with VR 103. More typically, a headset is used wherein a receiver (earpiece) and microphone are included. Illustrated devices 106 may be wirelessly operated or cabled to CPU 102 as is shown in this example.

A cursor (pointer) device (in this case a mouse) 104 is also part of the typical configuration as well as a keyboard (not shown). Mouse 104 may be wirelessly operated or cabled to CPU 102 as illustrated. A camera 107 is included in the configuration of this example. Camera 107 is typically cabled into CPU 102 as illustrated. Camera 107 is typically used for video conferencing, video chat, and for sending video e-mail messages.

In general, a dotted oval 108 indicates area of the prior-art configuration occupied by the face of an operator practicing voice input in using either of devices 106, and region 110 within area 108 is the area a user's mouth might be. VR software 103 is dependent on vocabulary, voice training to a particular user voice, and clear enunciation of words through microphones on devices 106. As described in the background section, this prior-art example offers less than optimum results that may be adversely effected by CPU speed, RAM size, level of voice training, inclusion of vocabulary, and user enunciation, to name a few. Any background noise that might occur in this example would also adversely affect the performance results of VR 103, perhaps including inadvertent input of noise into the software application that is erroneously interpreted as user input.

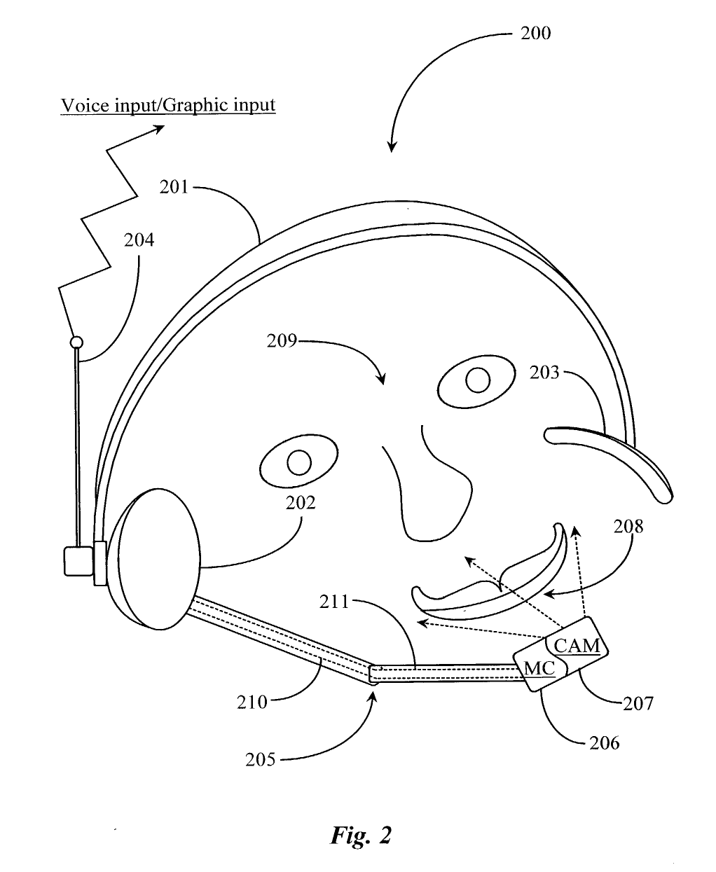

FIG. 2 is a perspective view of an input device 200 and user reference configured according to an embodiment of the invention. Input device 200 is similar in many respects to device 106 (headset) described with reference to FIG. 1 above. Headset 200 comprises a headband 201, a head stabilization piece 203 and an earpiece 202 for use in telephony applications.

Headband 200 is, in a preferred example, fabricated of durable and flexible polymer materials as are typical headbands associated with headsets. Stabilization piece 203 is, in a preferred embodiment, also fabricated of durable polymer. Earpiece 202 is assumed to contain all of the required components for enabling a sound-receiving device as known in the art including provision of comfortable foam-type interface material for interfacing a user's ear.

Headset 200 has an adjustable boom 205 affixed thereto substantially at the mounting position of earpiece 202. In this example, boom 205 has 2 adjustable members and may be presumed to also be rotably adjustable at its mounted location. It will be appreciated that there are many known designs and configurations available in the art for providing boom 205, any of which may be applicable in this and other embodiments of the invention.

A combination microphone camera device illustrated in FIG. 2 as integrated microphone (MC) 206 and camera (CAM) 207 is provided substantially at the free end of boom 205. Microphone 206 functions as a standard microphone adapted for user voice input. Camera 207 is adapted to provide moving pictures primarily of the mouth area of a user illustrated herein by a mouth 208. Cam 207 may be provided with a wide-angle lens function so as to enable a picture window that includes entire mouth 208 and additional features of the face of a user such as the user's eyes and nose illustrated herein as facial features 209.

Microphone 206 and camera 207 are connected through boom 205 by conductors 210 and 211 respectively. In this example, headset 200 is adapted for wireless communication by way of a transmitter/receiver system 204 including antenna. It may be assumed that a user operating headset 200 is communicating through a computer-based hardware system similar to desktop computer 100 described with reference to FIG. 1. However, headset 200 as an input peripheral may be adapted to work with a variety of computerized devices including Laptop computers, cellular telephony stations, and so on. In another embodiment, receiver/transmitter 204 is connected with a computer cable to the parent appliance.

In a preferred embodiment of the invention, voice recognition software is enhanced according to embodiments of the present invention to work with graphic images presented in the form of moving pictures via camera 207 of headset 200. In practice as a user speaks into microphone 206, camera 207 is operating and records facial movements of the user. Particularly, the movements of mouth 208 are provided to the computer equipment for analyzing in association with spoken words. Hence, a simultaneous double input containing sound and graphic input is delivered as a user speaks to VR software running on a suitable platform. Camera 207 can be rotatably adjustable to obtain the desired view of user facial features and may be focused through a mechanism running on an associated computer platform or by a mechanism (not shown) provided at the location of camera 207.

In one embodiment, camera 207 may be adapted with two lenses for focusing on a user and on what the user may be looking at or working with. In another embodiment two or more than two cameras 207 may be provided to capture different aspects and angles of a user's facial features wherein the recorded values representing those features may be combined to produce a synthesized picture of the user that is more complete and detailed.

The purpose of camera 207 is primarily dedicated to provision of measurable movements of mouth 208 while a user is speaking the measured values combined along with recognized speech to enhance accuracy of voice recognition software.

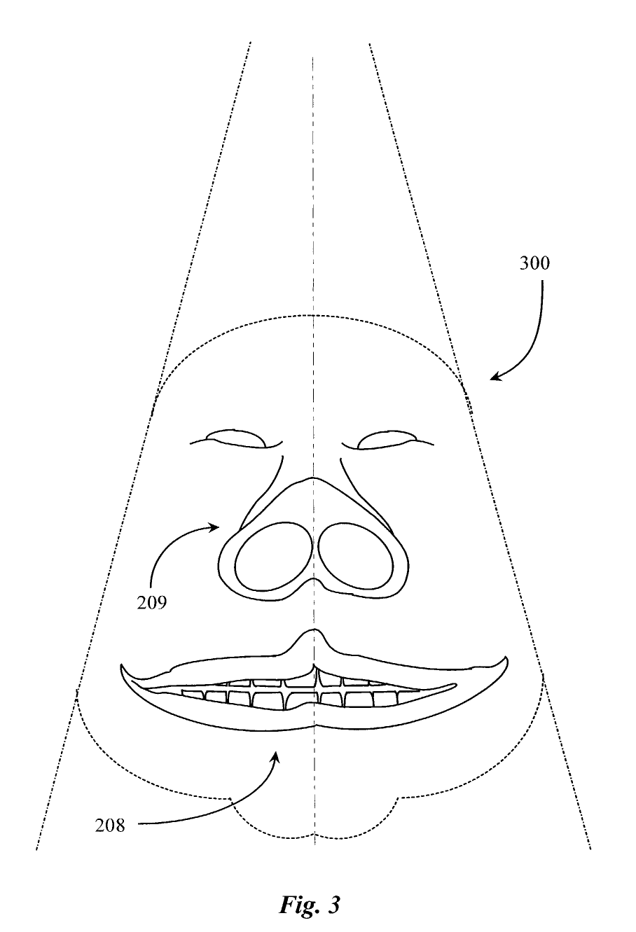

FIG. 3 is a plan view of a distorted camera view 300 of face area 209 and mouth 208 of the user of FIG. 2. Camera 207 of FIG. 2, because of position, will likely produce a somewhat distorted view (300) of a user. Such an exemplary view is illustrated in this example. Mouth 208 appears fairly accurate because of the position of the camera substantially in front of mouth 208. A wide-angle lens can produce a fairly accurate view. However, facial area 209 appears distorted due to camera positioning. For example, the view from underneath the nose of the user appears distorted with the effect of large nostrils. The eyes of the user appear narrower than they naturally are and less visible because of facial contours and direction of gaze. In some cases a user's eyes may not be visible at all.

If it is simply desired to focus solely on the feature (mouth) 208 of view 300 then an anti-distortion measure may not be required before facial movement (mouth) is tracked. However if facial expression, including eye movement and the like is to be included in tracking, then view 300 will have to be corrected before correct delta values being analyzed are utilized to enhance VR accuracy.

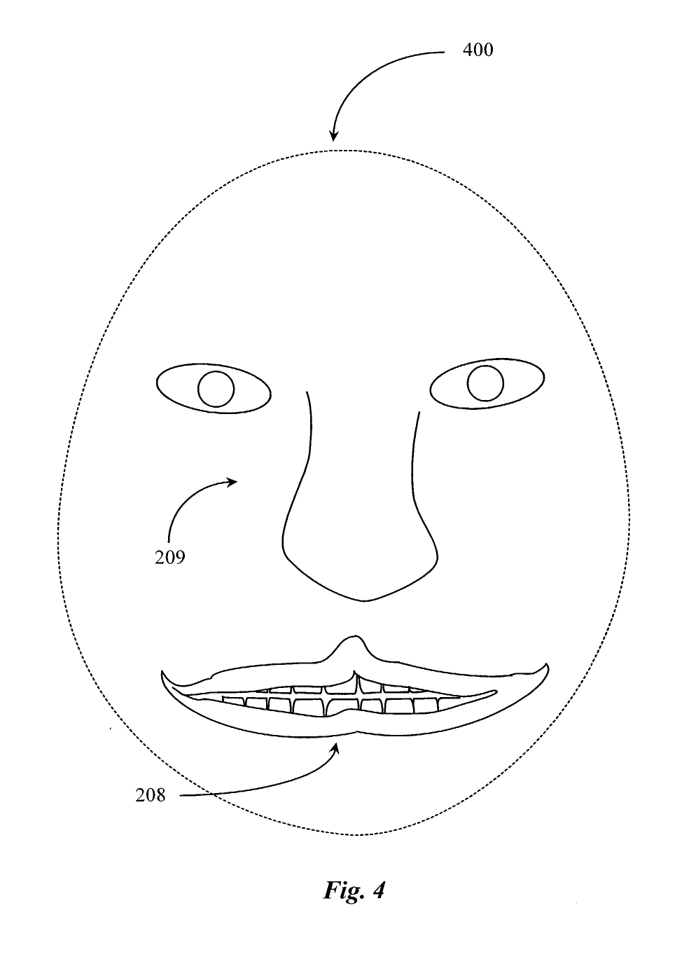

FIG. 4 is a plan view of a corrected camera view 400 of the same image taken in the example of FIG. 4. Camera view 400 is corrected to a more proportional view illustrating a front-on rendering of facial area 209 and mouth 208. It is noted herein that mouth 208 is not significantly different in this view, as it did not appear significantly distorted in view 300 described with reference to FIG. 3. Therefore, values tracked originally need not be altered significantly in production of a corrected image.

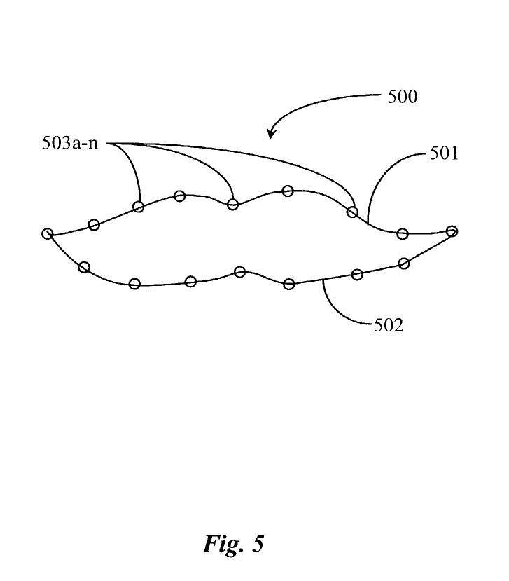

FIG. 5 is a diagram illustrating motion points 503a-n used for analyzing and processing delta motion by algorithm in an embodiment of the present invention. Motion points 503a-n represent positions along an upper lip 501 and a lower lip 502 of a user's mouth, which is analogous to mouth 208 described with reference to FIG. 4. In one embodiment, motion or tracking points 503a-n may be distributed strategically along the centerlines of lip 501 and lip 502. In another embodiment positioning may be relative to the periphery of lips 501 and 502. In still another embodiment, both centerline positions and periphery positions may be tracked and analyzed simultaneously. In a graphics embodiment, the deltas of motion recorded relevant to motion points 503a-n may be plotted on a motion graph (not shown) that may be superimposed over or integrated with the configuration array of motion points. During speech the motion deltas are recorded, combined and analyzed to produce probability values related to probable enunciations of words. For example, certain positions of all of the motion points may indicate consonant enunciation while certain other positions may indicate different vowel enunciations.

It will be appreciated by one with skill in the art that there may be any number of tracking points 503 a-n included in this example without departing from the spirit and scope of the present invention. In one embodiment, additional motion points may be added to record delta motion of the tip of a user's tongue during speech providing additional data to combine with lip movement. In still other embodiments, tracking points may also be added to eyebrow regions and certain mandible areas of the face that move during speech such as along the jaw line. In this case, certain punctuation indications may be ascertained without requiring the user to say them in the voice portion of the application. There are many possibilities.

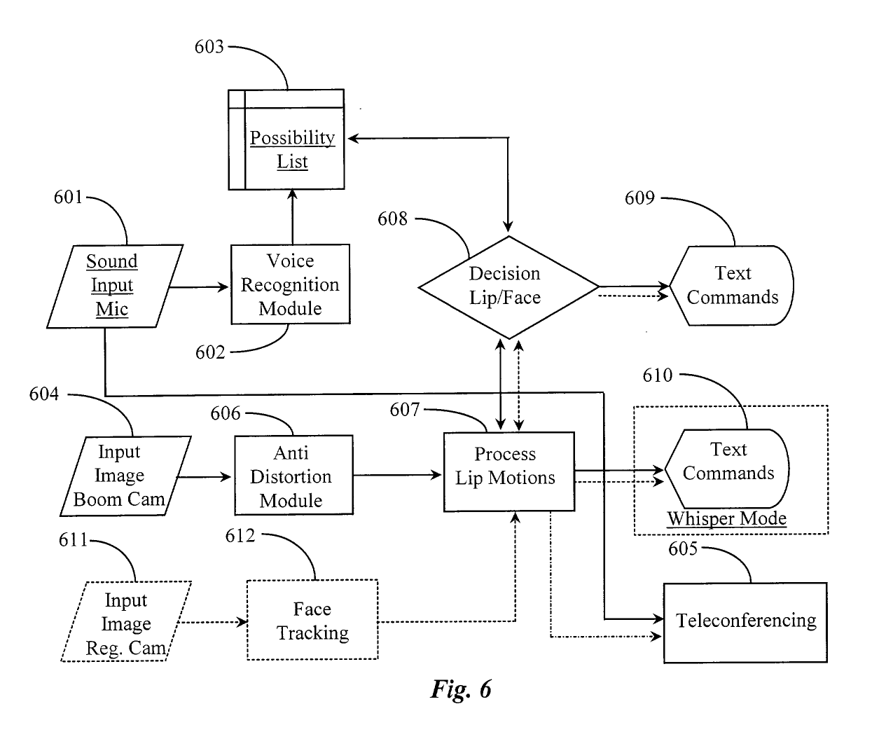

FIG. 6 is an overview of a visually aided voice recognition system according to an embodiment of the present invention. The voice recognition system of this preferred example differs markedly from prior-art systems by the addition of graphical input that is, in most embodiments, combined with voice input. In one embodiment termed a whisper mode by the inventor, graphic input alone is analyzed to produce recognition of speech.

In one embodiment a user speaks into input microphone 601, which microphone is analogous to microphone 206 described with reference to FIG. 3. It is noted herein that in one embodiment an input device other than a headset can be used such as a pedestal microphone with no speaker described as one possible device 106 with reference to FIG. 1. In that case a camera analogous to camera 207 of FIG. 2 would be provided for the camera tracking function.

Input microphone 601 delivers voice input to a voice recognition module that is part of the enhanced software running on an associated computer platform. Simultaneously, if the interaction involves communication over an active telephony link, voice spoken through microphone 601 is also delivered to a teleconferencing module 605 for transmission over a suitable data network such as the Internet network to another party or parties. In this case, perhaps a text rendering of the telephone conference is being produced in real time.

Voice recognition module 602 develops a text possibility list 603, which is temporarily stored until no longer required. This function is similar to existing voice recognition programs. Vocabulary libraries and user idiosyncrasies related to voice such as accent and the like are considered. It is assumed that the user has trained his or her voice and registered that particular style and tone.

Simultaneously, images of a user's facial features are being recorded in the fashion of moving pictures by image boom camera 604, which is analogous to camera 207 described with reference to FIG. 2. In one embodiment, the images (series of subsequent snapshots or short movie) is fed into an anti distortion module 606. Anti-distortion module 606 is part of the enhanced voice recognition software of the invention and may be adapted to function according to several variant embodiments.

In one embodiment, module 606 uses picture data already stored and accessible to the enhanced voice recognition application to mediate production of corrected image data. In this embodiment, a visual training step is provided when activating the application for the first time. In the visual session, the lips and other facial features of a user are recorded and measured using a regular camera with the user staring straight into the camera during the session. As a user reads from prepared text, the camera records the movement data and associates that movement data with the known speech similarly to the voice training exercise of prior-art applications. The stored data is subsequently used in recognition at later sessions. In one embodiment the voice and visual training are integrated as a single session using a same block of prepared text. The microphone and camera can be tested and optimally configured during the same session. In this case, a user with a different voice and facial arrangement would have to first train before being able to use the program successfully enhancing security.

In another embodiment, module 606 uses real time image data gathered from one of more regular cameras positioned around a user and focused in the user's general direction. In this embodiment, the image data from boom camera 604 and from the regular cameras is fresh (not previously known to the system). At first use then, a useful array of tracking points is established according to the just-received image data. Subsequently, tracking and enhanced recognition ensues during the same session. A slight delay may be necessary until proper text rendering can occur. Therefore, some pre-set preamble that is later cut out of a document may be appropriate to calibrate the system.

After a correct image data scenario exists, image data is fed into a processing module 607 for quantifying and calculating motion values. Motion values are time stamped and fed into a decision module 608 wherein they are cross-referenced to speech values accessed from store 603. Other methods of data synchronization can be used to match motion and voice data. Module 608 refines and corrects the data to produce the correct text commands or text renderings illustrated herein as text commands 609, which are inserted into a word processing document and displayed or rendered as operational commands that control other applications or processes. In a teleconferencing mode, commands for controlling other applications spoken to teleconferencing audiences will automatically invoke the same commands on the originators computing platform with the enhanced application running.

According to an alternative embodiment (dotted rectangle), one or more regular fixed cameras 611 are used for visual input instead of boom cam 604. In this case if there were only one camera then the user would be required to remain in view of that camera during session. If there is more than one camera 611 arrayed in a fashion as to capture different angles and combine the data, then the user could move about more freely. Image data from camera or cameras 611 are fed into face tracking software module 612. Module 612 is adapted to establish tracking points, if necessary, and to track the delta motion of those points as previously described. The values are fed into module 607 as previously described and processed. The final results are then fed into module 608, which processes the information as previously described. The text commands or renderings are displayed by module 609 as before. By using regular cameras, the anti-distortion module can be eliminated or bypassed. It will be appreciated by one with skill in the art that an imaging software module is associated with one or more cameras configured to the system. In one embodiment, cameras may be added or subtracted from the configuration of the system and imaging software may be dedicated and solely part of the software of the invention or may be standalone imaging modules or software programs that are integrated into the system of the invention but also have other imaging capabilities like security monitoring, picture manipulation, and so on.

In yet another embodiment for teleconferencing mode, sound input from microphone 601 is fed into teleconferencing module during an active teleconferencing session. Simultaneously, image data input from one or both of cameras 604 and 611 is processed accordingly by the enhanced recognition software at the sender's station and the final values are also fed into the teleconferencing module as attached call data. At the other end, a client application, which would be part of the system, receives the sound data and motion values and uses the motion values to enhance the quality of the conversation. It is presumed in this embodiment that the receiver application has access to the probability list and facial fingerprint of the sender to both verify identity and to effectively process the correct enhancements to the voice quality, which may be suffering dropout, interference by background noise, etc. In this case the weak portions of the voice transmission can be synthesized by correct voice deduced with the help of the motion values.

In still another embodiment, a user may whisper (whisper mode) when using the enhanced voice recognition system of the invention. This embodiment may be used for example when there is a plurality of users at individual stations in close proximity to one another, such as in a call center or technical service department. In this case, the software relies heavily on image data recorded by camera 604 and/or camera 611 to establish and produce motion values fed into module 607. Module 607 then feeds the values into module 608 for processing. The values are then returned to module 607 for delivery as text commands or test renderings displayed by module 610 at each local station for insert into word documents or used as commands for applications or other processes. In this embodiment, the overall noise level can be dramatically reduced and voice recognition software can be used successfully in close quarters by dozens of users.

One with skill in the art will appreciate that the methods and apparatus of the invention can be used to enhance voice recognition to levels that are not normally attained using traditional computing equipment. Furthermore, voice applications can be bridged from one location to another such as by way of a private network and distributed client software. In these scenarios, personal aspects of facial features as well as voice imprints can be used as security enhancements for those authorized, for example to access and change documents from a remote location. For example, a user in one station can initiate a call to a remote computer, once connected, he or she use voice commands and visual data to authenticate, access documents, and then use voice/visual recognition software to edit and make changes to those documents. The visual aspects resolved into recognition values provide an optimum remote embodiment where normal voice may dropout or be to inconsistent in terms of quality to enable the user to perform the required tasks using voice alone.

The present invention has been described in a preferred embodiment and in several other useful embodiments and therefore should be afforded a broad scope under examination. The spirit and scope of the invention should be limited only by the following claims.

What is claimed is:

1. An enhanced voice recognition system comprising:
a central processing unit for processing and storing data input into the system;
a microphone configured to the central processing unit for receiving audio input;
at least one camera configured to the central processing unit for receiving image data input; and
at least one software module for receiving, analyzing, and processing inputs;
characterized in that the system uses motion values from the image data to enhance the accuracy of voice recognition.

2. The system of claim 1 wherein the microphone and at least one camera are provided substantially at the end of a headset boom worn by the user.

3. The system of claim 1 wherein the microphone and at least one camera are provided substantially at the end of a pedestal-microphone.

4. The system of claim 1 where in the at least one camera includes a boom camera and at least one regular camera.

5. The system of claim 1 wherein the at least one software module includes voice recognition, image correction, motion tracking, motion value calculation, and text rendering based on comparison of motion values to text possibilities.

6. The system of claim 1 wherein the central processing unit enables a desktop computer.

7. The system of claim 1 further comprising:
a teleconferencing module;
a data link to a telecommunications network; and
a client application distributed to another central processing unit having access to the telecommunications network;
characterized in that the input image data is processed by the at least one software module and delivered as motion values to the teleconference module along with voice input, whereupon the motion values are attached to the voice data, transmitted over the telecommunications network, and processed by the distributed client application to enhance the quality of the transmitted voice data.

8. The system of claim 7 wherein the telecommunications network is the Internet network.

9. The system of claim 7 wherein the telecommunications network is a telephone network.

10. The system of claim 7 wherein the telecommunications network is a combination of the Internet network and a telephone network.

11. The system of claim 7 wherein the microphone and at least one camera are provided substantially at the end of a headset boom worn by the user.

12. The system of claim 7 wherein the microphone and at least one camera a provided substantially at the end of a pedestal-microphone.

13. The system of claim 7 where in the at least one camera includes a boom camera and at least one regular camera.

14. The system of claim 7 wherein the at least one software module includes voice recognition, image correction, motion tracking, combined motion value calculation, and text rendering based on comparison of motion values to text possibilities.

15. A software application for enhancing a voice recognition system comprising:
at least one imaging module associated with at least one camera for receiving image input;
at least one motion tracking module for tracking motion associated with facial positions of an image subject; and,
at least one processing module for processing and comparing processed motion values with voice recognition possibilities;
characterized in that the application establishes motion points and tracks the motion thereof during a voice recognition session, and the tracked motion is resolved into motion values that are processed in comparison with voice recognition values to produce enhanced voice recognition results.

16. The software application of claim 15 including a whisper mode wherein motion tracking and resulting values are relied more on than voice processing to produce accurate results.

17. The software application of claim 15 further comprising a teleconferencing module.

18. The software application of claim 17 wherein the values resulting from motion tracking are attached to voice data transmitted in a teleconferencing session through the teleconferencing module.

19. The software application of claim 17 including a client application distributed to the receiving central processing unit of a receiving station of the teleconference call.

20. A method for enhancing voice recognition results in a voice recognition system comprising:
(a) providing at least one camera and image software for receiving pictures of facial characteristics of a user during a voice recognition session;
(b) establishing motion tracking points at strategic locations on or about the facial features in the image window;
(c) recording the delta movements of the tracking points;
(d) combining the tracked motion deltas of individual tracking points to produce one or more motion value;
(e) comparing the motion values to voice recognition values and refining text choices from a list of possibilities; and
(f) displaying the enhanced text commands or renderings.

21. The method of claim 20 wherein in step (a) the at least one camera includes a boom camera and at least one fixed camera.

22. The method of claim 20 wherein in step (a) the at least one camera is a boom camera mounted to a headset boom.

23. The method of claim 20 wherein in step (a) the at least one camera is a fixed camera.

24. The method of claim 20 wherein in step (b) the tracking points are associated with one or more of the upper and lower lips of the user, the eyes and eyebrows of the user, and along the mandible areas of the user.

25. The method of claim 20 wherein in step (e) the motion values are relied on more heavily than the voice recognition values.
